(19) United States
(12) Patent Application Publication
(10) Pub. No.: US 2023/0267491 A1
(43) Pub. Date: Aug. 24, 2023

(54) SYSTEMS AND METHODS FOR MANAGING INSURANCE

(71) Applicant: BlueOwl, LLC, San Francisco, CA (US)

(72) Inventor: Blake Konrardy, Chicago, IL (US)

(21) Appl. No.: 18/162,846

(22) Filed: Feb. 1, 2023

Related U.S. Application Data
(60) Provisional application No. 63/312,446, filed on Feb. 22, 2022.

(51) Int. Cl. G06Q 30/0217; G06Q 40/08

(52) U.S. Cl. CPC G06Q 30/0217; G06Q 40/08

(57) ABSTRACT

Methods and systems for providing vehicle insurance discounts. For example, the method includes presenting, by a computing device, one or more questions to a user; receiving, from the user by the computing device, one or more responses to the one or more questions; determining, by the computing device, a first discount value for an insurance policy of a vehicle based at least in part upon the one or more responses; applying, by the computing device, the first discount value to the insurance policy of the vehicle for a predetermined period of time; collecting, by the computing device, driving data associated with one or more trips made by the vehicle during the predetermined period of time; analyzing, by the computing device, the driving data and the one or more responses; and determining, by the computing device, a first weight and a second weight based at least in part upon the driving data.

### CROSS REFERENCE TO RELATED APPLICATION

This application claims priority to U.S. Provisional Pat. Application No. 63/312,446, filed Feb. 22, 2022, which is incorporated by reference herein for all purposes.

### FIELD OF THE DISCLOSURE

Some embodiments of the present disclosure are directed to computer technology for insurance policy decisioning. More particularly, certain embodiments provide computer-implemented technology for vehicle insurance policy decisioning based upon user response data to questions and upon telematics data from the user vehicle trips. But it should be recognized that the present disclosure has much broader range of applicability.

### BACKGROUND OF THE DISCLOSURE

Conventional vehicle insurance policies are based upon various risk estimates of a driver (e.g., age, location, driving history, etc.). However, these policies suffer from drawbacks such as the lack of incentivizing preferred types of driving behaviors, failure to identify proper insurance ratings associated with the driver, inefficient customer communications, etc.

### BRIEF SUMMARY OF THE DISCLOSURE

Some embodiments of the present disclosure are directed to computer technology for use in connection with vehicle insurance policy decisioning based upon user response data to questions presented to the user and upon driving data associated with trips made by the vehicle. More particularly, certain embodiments include determining one or more weights used in connection one or more of the response data and the driving data. Merely by way of example, certain embodiments include determining discounts for vehicle insurance policies based upon the one or more weights.

According to certain embodiments, a method for providing vehicle insurance discounts includes presenting, by a computing device, one or more questions to a user, and receiving, from the user by the computing device, one or more responses to the one or more questions. Also, the method includes determining, by the computing device, a first discount value for an insurance policy of a vehicle based at least in part upon the one or more responses. Additionally, the method includes applying, by the computing device, the first discount value to the insurance policy of the vehicle for a predetermined period of time. Further, the method includes collecting, by the computing device, driving data associated with one or more trips made by the vehicle during the predetermined period of time. Moreover, the method includes analyzing, by the computing device, the driving data and the one or more responses. The method may also include determining, by the computing device, a first weight and a second weight based at least in part upon the driving data.

According to some embodiments, a computing device for providing vehicle insurance discounts includes one or more processors and a memory storing instructions for execution by the one or more processors. The instructions, when executed, cause the one or more processors to present one or more questions to a user and receive, from the user, one or more responses to the one or more questions. Also, the instructions, when executed, cause the one or more processors to determine a first discount value for an insurance policy of a vehicle based at least in part upon the one or more responses. Additionally, the instructions, when executed, cause the one or more processors to apply the first discount value to the insurance policy of the vehicle for a predetermined period of time. Further, the instructions, when executed, cause the one or more processors to collect driving data associated with one or more trips made by the vehicle during the predetermined period of time. Further, the instructions, when executed, cause the one or more processors to analyze the driving data and the one or more responses. Moreover, the instructions, when executed, cause the one or more processors to determine a first weight and a second weight based at least in part upon the driving data.

According to some embodiments, a non-transitory computer-readable medium stores instructions for providing vehicle insurance discounts. The instructions are executed by one or more processors of a computing device. The non-transitory computer-readable medium includes instructions to present one or more questions to a user, and to receive, from the user, one or more responses to the one or more questions. Also, the non-transitory computer-readable medium includes instructions to determine a first discount value for an insurance policy of a vehicle based at least in part upon the one or more responses. Additionally, the non-transitory computer-readable medium includes instructions to apply the first discount value to the insurance policy of the vehicle for a predetermined period of time. Further, the non-transitory computer-readable medium includes instructions to collect driving data associated with one or more trips made by the vehicle during the predetermined period of time. Further, the non-transitory computer-readable medium includes instructions to analyze the driving data and the one or more responses. Moreover, the non-transitory computer-readable medium includes instructions to determine a first weight and a second weight based at least in part upon the driving data.

According to some embodiments, a method for evaluating driving behaviors includes presenting, by a computing device, one or more questions to a user, and receiving, from the user by the computing device, one or more responses to the one or more questions. Also, the method includes analyzing, by the computing device, the one or more responses to determine a set of expected driving behaviors of the user for a predetermined period of time. Additionally, the method includes collecting, by the computing device, driving data associated with one or more trips made by a vehicle during the predetermined period of time. Further, the method includes analyzing, by the computing device, the driving data to determine a set of actual driving behaviors of the user. Moreover, the method includes determining, by the computing device, one or more relationships between the set of expected driving behaviors and the set of actual driving behaviors.

According to some embodiments, a computing device for evaluating driving behaviors includes one or more processors and a memory storing instructions for execution by the one or more processors. The instructions, when executed, cause the one or more processors to present one or more questions to a user, and receive, from the user, one or more responses to the one or more questions. Also, the instructions, when executed, cause the one or more processors to analyze the one or more responses to determine a set of expected driving behaviors of the user for a predetermined period of time. Additionally, the instructions, when executed, cause the one or more processors to collect driving data associated with one or more trips made by a vehicle during the predetermined period of time. Further, the instructions, when executed, cause the one or more processors to analyze the driving data to determine a set of actual driving behaviors of the user. Moreover, the instructions, when executed, cause the one or more processors to determine one or more relationships between the set of expected driving behaviors and the set of actual driving behaviors.

According to some embodiments, a non-transitory computer-readable medium stores instructions for evaluating driving behaviors. The instructions are executed by one or more processors of a computing device. The non-transitory computer-readable medium includes instructions to present one or more questions to a user, and to receive, from the user, one or more responses to the one or more questions. Also, the non-transitory computer-readable medium includes instructions to analyze the one or more responses to determine a set of expected driving behaviors of the user for a predetermined period of time. Additionally, the non-transitory computer-readable medium includes instructions to collect driving data associated with one or more trips made by a vehicle during the predetermined period of time. Further, the non-transitory computer-readable medium includes instructions to analyze the driving data to determine a set of actual driving behaviors of the user. Moreover, the non-transitory computer-readable medium includes instructions to determine one or more relationships between the set of expected driving behaviors and the set of actual driving behaviors.

According to some embodiments, a method for evaluating telematics-based insurance ratings includes receiving, by a computing device, a telematics-based insurance rating of a user, the telematics-based insurance rating being associated with a previous insurance provider for the user. Also, the method includes generating, by the computing device, an initial insurance discount for a vehicle of the user based at least in part upon the telematics-based insurance rating of the user, the initial insurance discount being associated with a current insurance provider for the user. Additionally, the method includes receiving, by the computing device, previous user data generated by the previous insurance provider, the previous user data representing one or more driving characteristics of the user. Further, the method includes analyzing, by the computing device, the previous user data to determine an updated insurance discount for the vehicle of the user.

According to some embodiments, a computing device for evaluating telematics-based insurance ratings includes one or more processors and a memory storing instructions for execution by the one or more processors. The instructions, when executed, cause the one or more processors to receive a telematics-based insurance rating of a user, the telematics-based insurance rating being associated with a previous insurance provider for the user. Also, the instructions, when executed, cause the one or more processors to generate an initial insurance discount for a vehicle of the user based at least in part upon the telematics-based insurance rating of the user, the initial insurance discount being associated with a current insurance provider for the user. Additionally, the instructions, when executed, cause the one or more processors to receive previous user data generated by the previous insurance provider, the previous user data representing one or more driving characteristics of the user. Moreover, the instructions, when executed, cause the one or more processors to analyze the previous user data to determine an updated insurance discount for the vehicle of the user.

According to some embodiments, a non-transitory computer-readable medium stores instructions for evaluating telematics-based insurance ratings. The instructions are executed by one or more processors of a computing device. The non-transitory computer-readable medium includes instructions to receive a telematics-based insurance rating of a user, the telematics-based insurance rating being associated with a previous insurance provider for the user. Also, the non-transitory computer-readable medium includes instructions to generate an initial insurance discount for a vehicle of the user based at least in part upon the telematics-based insurance rating of the user, the initial insurance discount being associated with a current insurance provider for the user. Additionally, the non-transitory computer-readable medium includes instructions to receive previous user data generated by the previous insurance provider, the previous user data representing one or more driving characteristics of the user. Further, the non-transitory computer-readable medium includes instructions to analyze the previous user data to determine an updated insurance discount for the vehicle of the user.

According to some embodiments, a method for sharing one or more vehicle insurance discounts includes analyzing, by a computing device, first driving data of a first user to determine one or more first driving behaviors of the first user. Additionally, the method includes determining, by the computing device, a discount value for an insurance policy of a vehicle based at least in part upon the one or more first driving behaviors of the first user. Further, the method includes receiving, by the computing device, information about a second user from the first user. Moreover, the method includes providing, to the second user by the computing device, the discount value of the first user to the second user. Also, the method includes receiving, from the second user by the computing device, an acceptance of the discount value. Furthermore, the method includes analyzing, by the computing device, second driving data of the second user to determine one or more second driving behaviors of the second user.

According to some embodiments, a computing device for sharing one or more vehicle insurance discounts includes one or more processors and a memory storing instructions for execution by the one or more processors. The instructions, when executed, cause the one or more processors to analyze first driving data of a first user to determine one or more first driving behaviors of the first user. Additionally, the instructions, when executed, cause the one or more processors to determine a discount value for an insurance policy of a vehicle based at least in part upon the one or more first driving behaviors of the first user. Further, the instructions, when executed, cause the one or more processors to receive information about a second user from the first user. Moreover, the instructions, when executed, cause the one or more processors to provide, to the second user, the discount value of the first user to the second user. Also, the instructions, when executed, cause the one or more processors to receive, from the second user, an acceptance of the discount value. Furthermore, the instructions, when executed, cause the one or more processors to analyze second driving data of the second user to determine one or more second driving behaviors of the second user.

According to some embodiments, a non-transitory computer-readable medium stores instructions for sharing one or more vehicle insurance discounts. The instructions are executed by one or more processors of a computing device. The non-transitory computer-readable medium includes instructions to analyze first driving data of a first user to determine one or more first driving behaviors of the first user. Also, the non-transitory computer-readable medium includes instructions to determine a discount value for an insurance policy of a vehicle based at least in part upon the one or more first driving behaviors of the first user. Additionally, the non-transitory computer-readable medium includes instructions to receive information about a second user from the first user. Further, the non-transitory computer-readable medium includes instructions to provide, to the second user, the discount value of the first user to the second user. Moreover, the non-transitory computer-readable medium includes instructions to receive, from the second user, an acceptance of the discount value. Furthermore, the non-transitory computer-readable medium includes instructions to analyze second driving data of the second user to determine one or more second driving behaviors of the second user.

According to some embodiments, a method for providing vehicle insurance discounts comprises presenting, by a computing device, one or more questions to a user, and receiving, from the user by the computing device, one or more initial responses to the one or more questions. Additionally, the method comprises determining, by the computing device, a first discount value for an insurance policy of a vehicle based at least in part upon the one or more initial responses. Further, the method comprises applying, by the computing device, the first discount value to the insurance policy of the vehicle for a predetermined period of time. Moreover, the method comprises collecting, by the computing device, driving data associated with one or more trips made by the vehicle during the predetermined period of time. Also, the method comprises analyzing, by the computing device, the driving data and the one or more initial responses. Furthermore, the method comprises determining, by the computing device, a first weight and a second weight based at least in part upon the driving data. Additionally, the method comprises collecting, by the computing device, one or more updated responses to the one or more questions. Moreover, the method comprises changing, by the computing device, the first weight and the second weight based at least in part upon the one or more updated responses.

According to some embodiments, a system for providing vehicle insurance discounts comprises means for presenting one or more questions to a user, and means for receiving one or more responses to the one or more questions. Additionally, the system comprises means for determining a first discount value for an insurance policy of a vehicle based at least in part upon the one or more responses. Further, the system comprises means for applying the first discount value to the insurance policy of the vehicle for a predetermined period of time. Moreover, the system comprises means for collecting driving data associated with one or more trips made by the vehicle during the predetermined period of time. Furthermore, the system comprises means for analyzing the driving data and the one or more responses. Also, the system comprises means for determining a first weight and a second weight based at least in part upon the driving data.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 shows a simplified method for providing vehicle insurance discounts according to certain embodiments of the present disclosure.

FIG. 2 shows a simplified method for evaluating driving behaviors according to certain embodiments of the present disclosure.

FIG. 3 shows a simplified method for evaluating telematics-based insurance ratings according to certain embodiments of the present disclosure.

FIG. 4 shows a simplified method for sharing one or more vehicle insurance discounts according to certain embodiments of the present disclosure.

FIG. 5 shows a simplified computing device for managing vehicle insurance according to certain embodiments of the present disclosure.

FIG. 6 shows a simplified system for managing vehicle insurance according to certain embodiments of the present disclosure.

### DETAILED DESCRIPTION OF THE DISCLOSURE

Some embodiments of the present disclosure are directed to computer technology for use in connection with vehicle insurance policy decisioning based upon user response data to questions presented to the user and upon driving data associated with trips made by the user of the vehicle. More particularly, certain embodiments include determining one or more weights used in connection with one or more of the response data and the driving data. Merely by way of example, certain embodiments include determining discounts for vehicle insurance policies based upon the one or more weights.

### I. Systems and Methods for Providing Vehicle Insurance Discounts According to Certain Embodiments

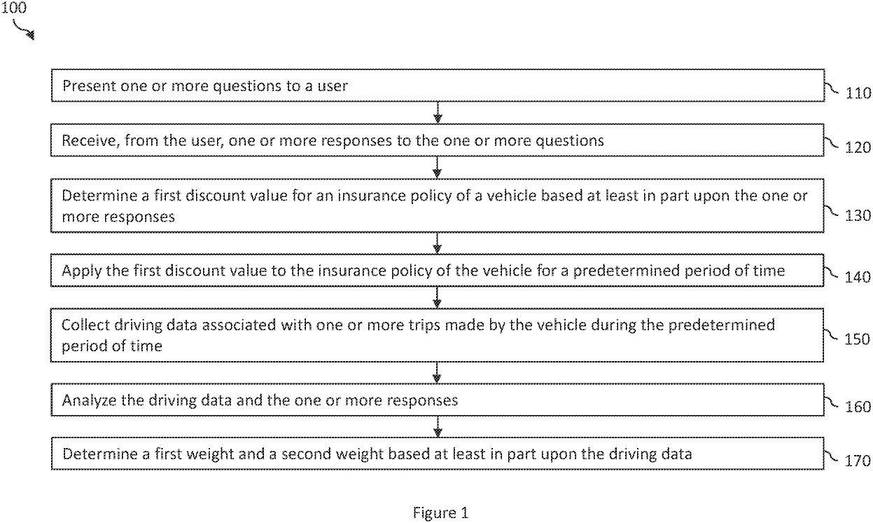

FIG. 1 is a simplified method for providing vehicle insurance discounts according to certain embodiments of the present disclosure. The diagram is merely an example, which should not unduly limit the scope of the claims. One of ordinary skill in the art would recognize many variations, alternatives, and modifications. The method 100 includes process 110 for presenting questions, process 120 for receiving responses, process 130 for determining a first discount, process 140 for applying the first discount, process 150 for collecting driving data, process 160 for analyzing the driving data and the responses, and process 170 for determining a first weight and a second weight. In one embodiment, certain steps may be done at server 606 such as presenting questions, responses by the user may be done at client device 612 and vehicle 610 may generate driving data. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, one or more questions are presented to a user according to certain embodiments. In various embodiments, the one or more questions may be sent from the server to the client device and ask how often the user drives, how many miles are driven per week (e.g., to work and/or total), how many passengers typically ride in the vehicle, does the user drive for a ride sharing platform, if the user or other drivers of the vehicle drive distracted, if there are any tendency to drive at excessive speed, if there are any tendency to drive long distances without taking a break, etc.

At the process 120, one or more responses from the user, for example, via client device to the one or more questions are received by the server according to certain embodiments. For example, the user provides an answer to each of the one or more questions or provides additional comments or clarifications.

At the process 130, the first discount value is determined, for example, at the server, for an insurance policy of the vehicle based at least in part upon the one or more responses according to certain embodiments. In some embodiments, the one or more responses are analyzed to determine the first discount value, which may be a percentage, an actual discount amount (e.g., dollar amount), a future credit, a gift card, or a combination thereof. For example, if the one or more responses indicate that the user does not drive often and has a cautious driving style, then a high value may be determined for the first discount value. As an example, if the one or more responses indicate that the user drives often and has a more adventurous driving style, then a low value may be determined for the first discount value. In still another embodiment, the discount may have no value.

At the process 140, the first discount value is applied to the insurance policy of the vehicle for a predetermined period of time according to certain embodiments. For example, the predetermined period of time may be 2 weeks, one month, 6 weeks, 2 months, etc. in duration. As an example, a premium or cost associated with the first month of the insurance policy is reduced by an amount equal to the first discount value.

At the process 150, the driving data associated with one or more trips made the vehicle during the predetermined period of time are collected according to certain embodiments. In some embodiments, the driving data include information related to a driving behavior of the user during the predetermined period of time. For example, the driving data indicate how frequently the user drives, type of maneuvers that the user makes while driving, types of road that the user drives on, number of reported accidents/collisions, types of dangerous driving events, and/or types of safe driving events. In still another embodiment, the driving data may be collected for a certain number of trips by the user and/or over a period of time. For example, 10 trips must be taken over a 2-week period and the like. In certain embodiments, the driving data are collected from one or more sensors (e.g., accelerometers, gyroscopes, barometers, GPS sensors, etc.) associated with the vehicle or from the similar sensors of the client device as noted below. The driving data may be sent from the vehicle and/or the client device depending on the embodiment and as noted below. As more driving data is collected the credibility of the data is increased and thus more weight can be given to the driving data. Similarly, as more responses are provided or updated, then more credibility is given to the responses and more weight can be given to the responses.

At the process 160, the driving data and the one or more responses are analyzed (e.g., at the server) according to certain embodiments. For example, analyzing the driving data and the one or more responses may be done at the server and includes assessing how the driving data compare to the one or more responses.

At the process 170, a first weight and a second weight are determined based at least in part upon the driving data according to certain embodiments. In various embodiments, the first and second weights represent a credibility rating. For example, the first weight represents the credibility of the driving data. As an example, the second weight represents the credibility of the one or more responses. In some embodiments, the first and second weights are percentage values. For example, the first weight is represented by X percent, and the second weight is represented by Y percent, wherein the sum of X percent and Y percent is equal to 100%. As an example, X percent is applied to the driving data while Y percent is applied to the one or more responses. For example, the percentages are applied as a way to rate the importance of the driving data relative to the one or more responses. In certain embodiments, for example, the first and/or second weights may increase or decrease based upon the credibility of the driving data. In embodiments, for example, data such as driving data becomes more credible with increasing amounts of received data.

In certain embodiments, the first and second weights are determined and continuously adjusted based upon how much driving experience has been obtained by analyzing the driving data and changes to the responses, if any. In some embodiments, the driving data corresponds to a driving mileage and/or to a number of trips. For example, if the driving mileage increases but remains smaller than a predetermined mileage threshold, then the first weight is increased and the second weight is decreased. As an example, if the driving mileage reaches or becomes larger than the predetermined mileage threshold, then the first weight is set to equal to one and the second weight is set to equal to zero. For example, if 100 hours of driving is considered to be fully credible, then for every trip that the user takes, more weight is given to the driving data (e.g., increasing the first weight) and less weight is assigned to the one or more responses (e.g., decreasing the second weight). As an example, if 100 hours of driving has been reached, then a full amount of weight is given to the driving data (e.g., setting the first weight to one and the second weight to zero). As another example, the first and second weights can be determined based upon the amounts of driving per periods of time. For example, if the amount of driving reaches a predetermined amount or threshold (such as for example a predetermined number of driving hours or a predetermined number of driving miles) during a predetermined period of time (e.g., two weeks), more weight is given to the driving data (e.g., increasing the first weight) and less weight is assigned to the one or more responses (e.g., decreasing the second weight).

In certain embodiments, the first and second weights may be determined based upon the number of driving trips. For example, if the number of driving trips reaches a predetermined threshold (e.g., 300 trips), more or all of the weight can be given to the driving data. In certain embodiments, before the threshold number of driving trips is reached, the user responses either alone or in combination with the driving data can be used to determine the discount. For example, a weighted average of the actual driving data and the user responses can be used to determine the discount before the predetermined number of driving trips is reached. In certain embodiments, the first weight used in the weighted average can increase based upon the number of driving trips (e.g., with increasing numbers of driving trips) before the predetermined number of driving trips is reached. In another embodiment, the number of trips can be tied to a minimum of miles driving before they can be counted.

In some embodiments, one or more second weighted factors are determined based at least in part upon the second weight and the one or more responses. In certain embodiments, the one or more second weighted factors include one or more weighted responses. For example, the one or more weighted responses are determined by applying the second weight to the one or more responses and as more responses are received or updated, the more credibility can be given to the one or more responses. In certain embodiments, one or more first weighted factors are determined based at least in part upon the first weight and the driving data. In some embodiments, the one or more first weighted factors include one or more weighted driving data. For example, the one or more weighted driving data are determined by applying the first weight to the driving data.

In certain embodiments, a second discount value for the insurance policy of the vehicle is determined based at least in part upon the one or more first weighted factors and the one or more second weighted factors. In some embodiments, the second discount value is determined based at least in part upon the weighted responses and the weighted driving data. In some embodiments, after the predetermined period of time, the first discount value is replaced with the second discount value and the second discount value is applied to the insurance policy of the vehicle. For example, the second discount value is applied to the insurance policy of the vehicle for one or more subsequent months covered by the insurance policy. Additionally, or alternatively, in certain embodiments the first and second weights can change over time and/or based upon the amount of data (e.g., driving data) is obtained. In certain embodiments, for example, during a first period of time (e.g., a first month) only the response data may be used to determine the first discount, and/or during a second period of time (e.g., a subsequent month) only the driving data may be used to determine the second discount. In certain embodiments, the first and/or second discounts are determined as a function of the first and/or second weights and the driving data and/or the response data so they can be adjusted up or down depending on the changes in their credibility.

### II. Systems and Methods for Evaluating Driving Behaviors According to Certain Embodiments

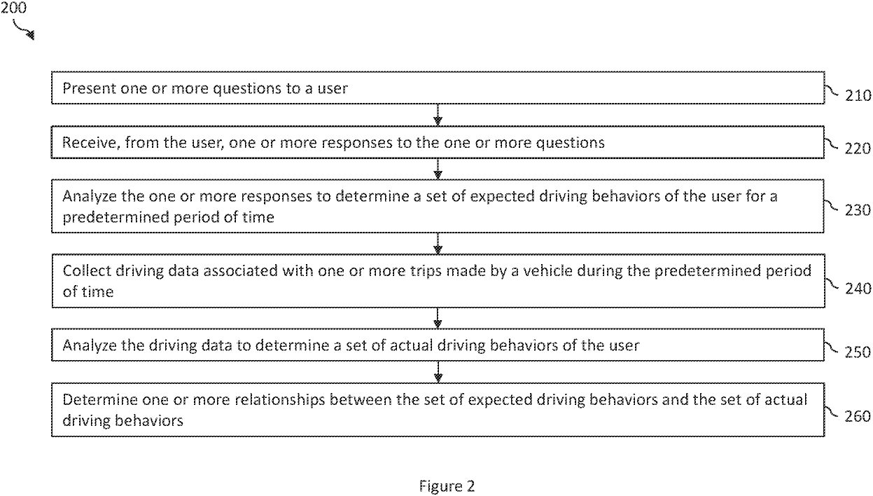

FIG. 2 is a simplified method for evaluating driving behaviors according to certain embodiments of the present disclosure. The diagram is merely an example, which should not unduly limit the scope of the claims. One of ordinary skill in the art would recognize many variations, alternatives, and modifications. The method 200 includes process 210 for presenting questions, process 220 for receiving responses, process 230 for analyzing the responses to determine expected driving behaviors, process 240 for collecting driving data, process 250 for analyzing the driving data to determine actual driving behaviors, and process 260 for determining relationships between the expected driving behaviors and the actual driving behaviors. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 210, one or more questions are presented to a user according to certain embodiments. In various embodiments, the one or more questions may be sent from the server to the client device and ask, as examples, how often the user drives, how many miles are driven per week (e.g., to work and/or total), how many passengers typically ride in the vehicle, does the user drive for a ride sharing platform, if there are any tendency to drive at excessive speed, if there are any tendency to drive long distances without taking a break, etc.

At the process 220, one or more responses from the user to the one or more questions are received according to certain embodiments. For example, the user provides answers to each of the one or more questions.

At the process 230, the one or more responses are analyzed to determine a set of expected driving behaviors of the user for a predetermined period of time according to certain embodiments. For example, the predetermined period of time may be one month in duration. In some embodiments, if the one or more responses show that the user does not drive often and/or does not speed while driving, then analyzing the one or more responses will indicate cautious driving for the set of expected driving behaviors. In certain embodiments, if the one or more responses show that the user drives often and/or accelerates/decelerates often while driving, then analyzing the one or more responses will indicate adventurous driving for the set of expected driving behaviors.

At the process 240, the driving data associated with one or more trips made the vehicle during the predetermined period of time are collected according to certain embodiments. In certain embodiments, the driving data are collected from one or more sensors (e.g., accelerometers, gyroscopes, barometers, GPS sensors, etc.) associated with the vehicle.

At the process 250, the driving data are analyzed to determine a set of actual driving behaviors of the user according to certain embodiments. In various embodiments, the driving data indicate how frequently the user drives, type of maneuvers that the user makes while driving, types of dangerous driving events, types of safe driving events, number of reported accidents, etc. For example, the driving data are analyzed to determine the user’s actual driving style for the set of actual driving behaviors.

At the process 260, one or more relationships between the set of expected driving behaviors and the set of actual driving behaviors are determined according to certain embodiments. In various embodiments, the one or more relationships indicate consistencies or discrepancies between the set of expected driving behaviors and the set of actual driving behaviors (e.g., how the user’s expected driving as derived from the one or more responses compare to the user’s actual driving as derived from the driving data). For example, a consistency exists between the set of expected driving behaviors and the set of actual driving behaviors if the user indicated in the one or more responses that the user is a cautious driver and the driving data show that the user practices cautious or safe driving. As an example, a discrepancy exists between the set of expected driving behaviors and the set of actual driving behaviors if the user indicated in the one or more responses that the user is a cautious driver, but the driving data show the user practices adventurous or unsafe driving. In some embodiments, any consistency or discrepancy between the set of expected driving behaviors and the set of actual driving behaviors is used as a predictor of how confident the user is with his/her own driving.

In some embodiments, if the one or more relationships between the set of expected driving behaviors and the set of actual driving behaviors satisfy one or more predetermined conditions, then the set of expected driving behaviors is determined to be validated. In certain embodiments, if the one or more relationships between the set of expected driving behaviors and the set of actual driving behaviors do not satisfy the one or more predetermined conditions, then the set of expected driving behaviors is determined to be not validated. For example, the one or more predetermined conditions may indicate whether two sets of driving behaviors are the same. As an example, validating the set the expected driving behaviors denotes that the set of expected driving behaviors matches the set of actual driving behaviors. For example, not validating the set the expected driving behaviors denotes that the set of expected driving behaviors does not match the set of actual driving behaviors.

In certain embodiments, the one or more relationships between the set of expected driving behaviors and the set of actual driving behaviors are analyzed to determine a discount value to an insurance policy for the vehicle of the user. For example, the one or more relationships are used as inputs into a machine learning model to determine how the one or more relationships correlate with insurance risks. As an example, results from the machine learning model can be used to determine the discount value and/or price to the insurance policy for the vehicle of the user. For example, the user may answer questions stating that he/she does never uses a mobile device while driving (e.g., 0%). As an example, the user’s driving data may show that the user is using the mobile device at least some of the times while driving (e.g., 30%). For example, the difference between these two numbers can be used as a feature to be inputted into the machine learning model to calculate an appropriate discount and/or price for the user. As an example, the discount and/or price for the user will be different than other users who indicated that they use their mobile devices 35% of the time while driving and their driving data actually show a 30% usage while driving.

### III. Systems and Methods for Evaluating Telematics-Based Insurance Ratings According to Certain Embodiments

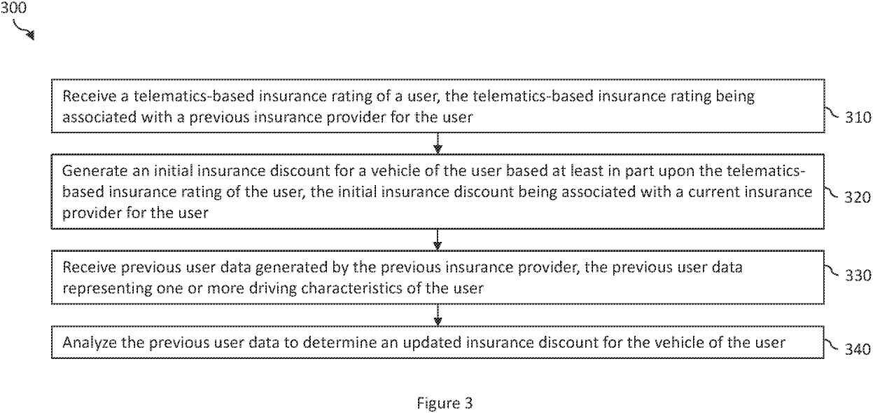

FIG. 3 is a simplified method for evaluating telematics-based insurance ratings according to certain embodiments of the present disclosure. The diagram is merely an example, which should not unduly limit the scope of the claims. One of ordinary skill in the art would recognize many variations, alternatives, and modifications. The method 300 includes process 310 for receiving a telematics-based insurance rating, process 320 for generating an initial insurance discount, process 330 for receiving previous user data, and process 340 for analyzing the previous user data to determine an updated insurance discount. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 310, the telematics-based insurance rating of a user is received according to certain embodiments. In various embodiments, the telematics-based insurance rating is associated with a previous insurance provider for the user. For example, the user may be assigned a driving score based on the user’s telematics data when the user was insured under the previous insurance provider. As an example, the user provides the driving score as the telematics-based insurance rating. Alternatively or additionally, in certain embodiments the telematics data or insurance rating can be obtained from one or more other third parties that collect or possess relevant information. In embodiments, such telematics data or insurance rating obtained from third parties can be used, or used to determine, the telematics-based insurance rating at the process 310. The rating may be based on a standard rating, such as for example that used in the insurance field, or similar to a FICO score for a credit rating used in the financial industry or other relevant industries. Alternatively or additionally, in certain embodiments other data, including for example data obtained from third parties, can be used by the process 310. For example, such other types of data can include the types of fuel used by the user in their vehicle, the times that they fuel their vehicle, or vehicle maintenance and status (e.g., damage) information (e.g., “non-driving” data).

At the process 320, the initial insurance discount for a vehicle of the user is generated based at least in part upon the telematics-based insurance rating of the user according to certain embodiments. In various embodiments, the initial insurance discount is associated with a current insurance provider for the user. Similar to step 140, the discount can be given for a predetermined amount of time.

At the process 330, the previous user data generated by the previous insurance provider are received according to certain embodiments. In some embodiments, the previous user data are received from the user. For example, the previous user data may be captured by one or more screenshots. As an example, the user can import the one or more screenshots using any suitable methods, such as computer vision techniques, manual entries, etc. In certain embodiments, the previous user data are received from the previous insurance provider. For example, a scraping tool can be used to access a website and/or application associated with the previous insurance provider on behalf of the user to collect/retrieve the previous user data. As an example, direct integration can be implemented with the previous insurance provider to collect/retrieve the previous user data. For example, the current insurance provider may receive the user’s permission to use the user’s credentials. As an example, the current insurance provider may transmit a request to the previous insurance provider for the previous user data via the user’s credentials. As an example, upon verification, the previous insurance provider may allow the current insurance provider access any or all of the previous user data belonging to the user.

In various embodiments, the previous user data represent one or more driving characteristics of the user. In some embodiments, the one or more driving characteristics include driving/trip data obtained from the previous insurance provider that indicate how frequently the user drove, type of maneuvers that the user made while driving, types of road that the user drove on, types of dangerous/safe driving events, number of reported accidents, etc. In certain embodiments, the one or more driving characteristics include various subscores obtained from the previous insurance provider (e.g., hard braking score, hard acceleration score, excessive speed score, etc.). In some embodiments, the one or more driving characteristics include an overall score obtained from the previous insurance provider. In certain embodiments, the one or more driving characteristics include a telematics discount (e.g., a discount value or percentage) obtained from the previous insurance provider.

At the process 340, the previous user data are analyzed to determine the updated insurance discount for the vehicle of the user according to certain embodiments. For example, the previous user data are analyzed to determine a driving score which forms the basis of the updated insurance discount.

In some embodiments, whether one or more relationships between the initial insurance discount and the updated insurance discount satisfy one or more predetermined conditions are determined. In various embodiments, the one or more relationships indicate consistencies or discrepancies between the initial insurance discount and the updated insurance discount. For example, a consistency exists between the initial insurance discount and the updated insurance discount if the initial insurance discount matches the updated insurance discount. As an example, a discrepancy exists between the initial insurance discount and the updated insurance discount if the initial insurance discount is different than the updated insurance discount.

In certain embodiments, if the one or more relationships between the initial insurance discount and the updated insurance discount satisfy the one or more predetermined conditions, then the initial insurance discount is determined to be verified. In some embodiments, if the one or more relationships between the initial insurance discount and the updated insurance discount do not satisfy the one or more predetermined conditions, then the initial insurance discount is determined to be not verified. For example, the one or more predetermined conditions may indicate whether two insurance discounts are the same or within acceptable parameters. As an example, verifying the initial insurance discount denotes that the initial insurance discount matches the updated insurance discount or varies within acceptable parameters. For example, not verifying the initial insurance discount denotes that the initial insurance discount does not match the updated insurance discount or is not within acceptable parameters.

### IV. Systems and Methods for Sharing One or More Vehicle Insurance Discounts According to Certain Embodiments

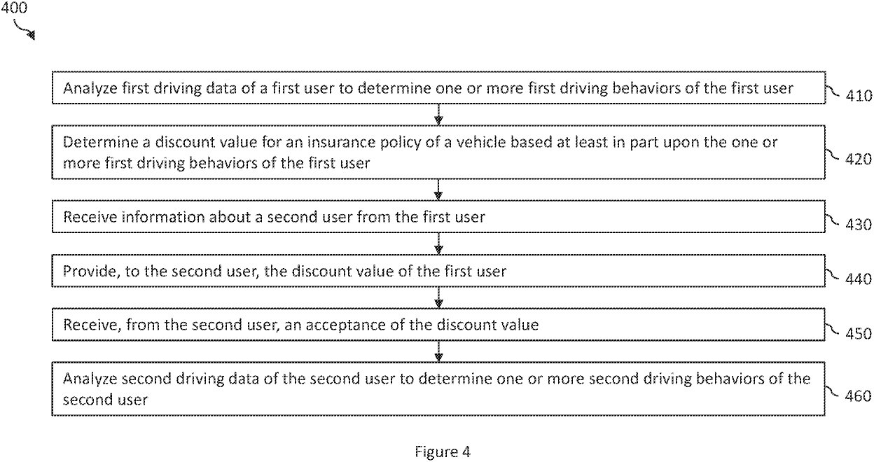

FIG. 4 is a simplified method for sharing one or more vehicle insurance discounts according to certain embodiments of the present disclosure. The diagram is merely an example, which should not unduly limit the scope of the claims. One of ordinary skill in the art would recognize many variations, alternatives, and modifications. The method 400 includes process 410 for analyzing first driving data of a first user, process 420 for determining a discount value, process 430 for receiving information about a second user, process 440 for providing the discount value to the second user, process 450 for receiving an acceptance of the discount value, and process 460 for analyzing second driving data of the second user. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 410, the first driving data of the first user are analyzed to determine one or more first driving behaviors of the first user according to certain embodiments. In various embodiments, the first driving data indicate how frequently the first user drives, type of maneuvers that the first user makes while driving, types of dangerous/safe driving events, number of reported accidents associated with the first user, etc. For example, the first driving data are analyzed to determine the first user’s driving style for the one or more first driving behaviors.

At the process 420, the discount value for an insurance policy of a vehicle is determined based at least in part upon the one or more first driving behaviors of the first user according to certain embodiments. For example, if the one or more first driving behaviors indicate that the first user does not drive often and has a cautious driving style, then a high value may be determined for the discount value. As an example, if the one or more first driving behaviors indicate that the first user drives often and has a more adventurous driving style, then a low value may be determined for the discount value. Examples of other driving behaviors of the first user that may be used at the process 420 include how often the user drives, how many miles are driven per week (e.g., to work and/or total), how many passengers typically ride in the vehicle, does the user drive for a ride sharing platform, if there is any tendency to drive at excessive speed, if there is any tendency to drive long distances without taking a break, etc.

At the process 430, the information about the second user is received from the first user according to certain embodiments. For example, the first user refers the second user to an insurance provider of the first user. In various embodiments, the second user is a person familiar to the first user (e.g., a friend, a colleague, a family member, etc.) that the first user would like to share the discount value with.

At the process 440, the discount value of the first user is provided to the second user according to certain embodiments. At the process 450, the acceptance of the discount value is received from the second user according to some embodiments. For example, a referral link (e.g., an email, a text message, QR code etc.) indicating the discount value is provided to the second user. As an example, the second user decides to use the discount value and acknowledges acceptance of the discount value.

At the process 460, the second driving data of the second user are analyzed to determine one or more second driving behaviors of the second user according to certain embodiments. In various embodiments, the second driving data indicate how frequently the second user drives, type of maneuvers that the second user makes while driving, types of dangerous/safe driving events, number of reported accidents associated with the second user, etc. For example, the second driving data are analyzed to determine the second user’s driving style for the one or more second driving behaviors.

In some embodiments, the one or more second driving behaviors are compared with the one or more first driving behaviors to determine one or more differences. For example, the one or more differences indicate whether the one or more first driving behaviors are similar or dissimilar to the one or more second driving behaviors. As an example, comparing the one or more first driving behaviors and the one or more second driving behaviors may indicate that both the first user and the second user are safe drivers. For example, comparing the one or more first driving behaviors and the one or more second driving behaviors may indicate that the first user is a safe driver but the second user is an unsafe driver.

In certain embodiments, a reward for the first user is determined based at least in part upon the one or more differences. For example, the reward may be an additional 25% of the current discount. In some embodiments, if the one or more differences indicate that the second user’s driving behavior is similar to the first user’s driving behavior, then the first user is presented with the reward for his/her endorsement of the second user. For example, if the first user shares with the second user a 50% discount and the second user earns a 45% discount, then the first user may receive a large reward, such as an additional 20% (e.g., 20% more of the 50% discount) because the second user is a good driver even though the second user is not as good as the first user. In certain embodiments, if the one or more differences indicate that the second user’s driving behavior is only half as good as the first user’s driving behavior, then the first user is presented with half of the reward amount or additional 12.5% of the current 50% discount. In some embodiments, if the one or more differences indicate that the second user’s driving behavior is twice as good as the first user’s driving behavior, then the first user is presented with double of the reward amount or additional 25% of the current 50% discount. In certain embodiments, if the one or more differences indicate that the second user’s driving behavior is a lot worse than that of the first user, then no reward is presented to the first user.

In various embodiments, the reward may be cash, a gift card, a coupon, a credit statement, a premium adjustment, etc. In some embodiments, the reward for the first user is determined based at least in part upon the one or more second driving behaviors.

### V. One or More Computing Devices for Managing Vehicle Insurance According TO Certain Embodiments

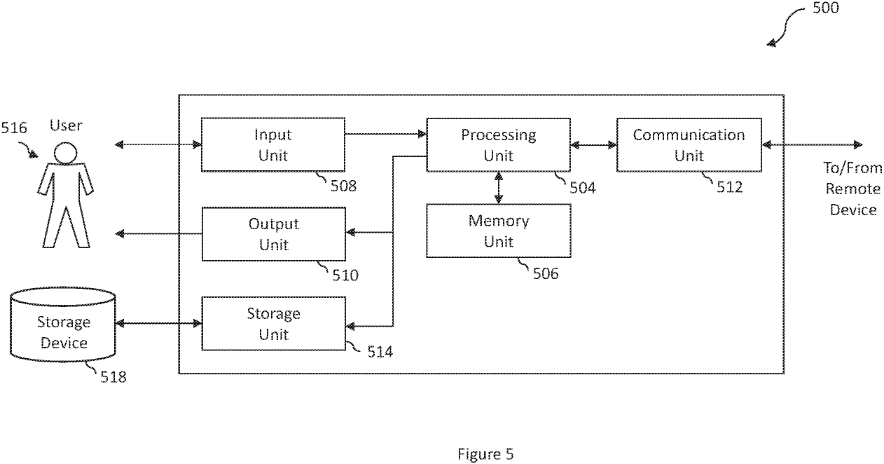

FIG. 5 is a simplified computing device for managing vehicle insurance according to certain embodiments of the present disclosure. The diagram is merely an example, which should not unduly limit the scope of the claims. One of ordinary skill in the art would recognize many variations, alternatives, and modifications. The computing device 500 includes a processing unit 504, a memory unit 506, an input unit 508, an output unit 510, a communication unit 512, and a storage unit 514. In various embodiments, the computing device 500 is configured to be in communication with a user 516 and/or a storage device 518. In some embodiments, the computing device 500 is configured to implement the method 100 of FIG. 1, the method 200 of FIG. 2, the method 300 of FIG. 3, and/or the method 400 of FIG. 4. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the processing unit 504 is configured for executing instructions, such as instructions to implement the method 100 of FIG. 1, the method 200 of FIG. 2, the method 300 of FIG. 3, and/or the method 400 of FIG. 4. In some embodiments, the executable instructions are stored in the memory unit 506. In certain embodiments, the processing unit 504 includes one or more processing units (e.g., in a multi-core configuration). In some embodiments, the processing unit 504 includes and/or is communicatively coupled to one or more modules for implementing the methods and systems described in the present disclosure. In certain embodiments, the processing unit 504 is configured to execute instructions within one or more operating systems. In some embodiments, upon initiation of a computer-implemented method, one or more instructions is executed during initialization. In certain embodiments, one or more operations is executed to perform one or more processes described herein. In some embodiments, an operation may be general or specific to a particular programming language (e.g., C, C++, Java, or other suitable programming languages, etc.).

In various embodiments, the memory unit 506 includes a device allowing information, such as executable instructions and/or other data to be stored and retrieved. In some embodiments, the memory unit 506 includes one or more computer readable media. In certain embodiments, the memory unit 506 includes computer readable instructions for providing a user interface, such as to the user 516, via the output unit 510. In some embodiments, a user interface includes a web browser and/or a client application. For example, a web browser enables the user 516 to interact with media and/or other information embedded on a web page and/or a website. In certain embodiments, the memory unit 506 includes computer readable instructions for receiving and processing an input via the input unit 508. In some embodiments, the memory unit 506 includes RAM such as dynamic RAM (DRAM) or static RAM (SRAM), ROM, erasable programmable read-only memory (EPROM), electrically erasable programmable read-only memory (EEPROM), and/or non-volatile RAM (NVRAM).

In various embodiments, the input unit 508 is configured to receive input (e.g., from the user 516). In some embodiments, the input unit 508 includes a keyboard, a pointing device, a mouse, a stylus, a touch sensitive panel (e.g., a touch pad or touch screen), a gyroscope, an accelerometer, a position sensor (e.g., GPS sensor), and/or an audio input device. In certain embodiments, the input unit 508 is configured to function as both an input unit and an output unit.

In various embodiments, the output unit 510 includes a media output unit configured to present information to the user 516. In some embodiments, the output unit 510 includes any component capable of conveying information to the user 516. In certain embodiments, the output unit 510 includes an output adapter such as a video adapter and/or an audio adapter. For example, the output unit 510 is operatively coupled to the processing unit 504 and/or a visual display device to present information to the user 516 (e.g., a liquid crystal display (LCD), a light emitting diode (LED) display, an organic light emitting diode (OLED) display, a cathode ray tube (CRT) display, a projected display, etc.). As an example, the output unit 510 is operatively coupled to the processing unit 504 and/or an audio display device to present information to the user 516 (e.g., a speaker arrangement or headphones).

In various embodiments, the communication unit 512 is configured to be communicatively coupled to a remote device. In some embodiments, the communication unit 512 includes a wired network adapter, a wireless network adapter, a wireless data transceiver for use with a mobile phone network (e.g., 3G, 4G, 5G, Bluetooth, etc.), and/or other mobile data networks. In certain embodiments, other types of short-range or long-range networks may be used. In some embodiments, the communication unit 512 is configured to provide email integration for communicating data between a server and one or more clients.

In various embodiments, the storage unit 514 is configured to enable communication between the computing device 500 and the storage device 518. In some embodiments, the storage unit 514 is a storage interface. For example, the storage interface is any component capable of providing the processing unit 504 with access to the storage device 518. In certain embodiments, the storage unit 514 includes an advanced technology attachment (ATA) adapter, a serial ATA (SATA) adapter, a small computer system interface (SCSI) adapter, a RAID controller, a SAN adapter, a network adapter, and/or any other component capable of providing the processing unit 504 with access to the storage device 518.

In various embodiments, the storage device 518 includes any computer-operated hardware suitable for storing and/or retrieving data. In certain embodiments, the storage device 518 is integrated in the computing device 500. In some embodiments, the storage device 518 includes a database such as a local database or a cloud database. In certain embodiments, the storage device 518 includes one or more hard disk drives. In some embodiments, the storage device 518 is external and is configured to be accessed by a plurality of server systems. In certain embodiments, the storage device 518 includes multiple storage units such as hard disks or solid state disks in a redundant array of inexpensive disks configuration. In some embodiments, the storage device 518 includes a storage area network and/or a network attached storage system.

### VI. One or More Systems for Managing Vehicle Insurance According to Certain Embodiments

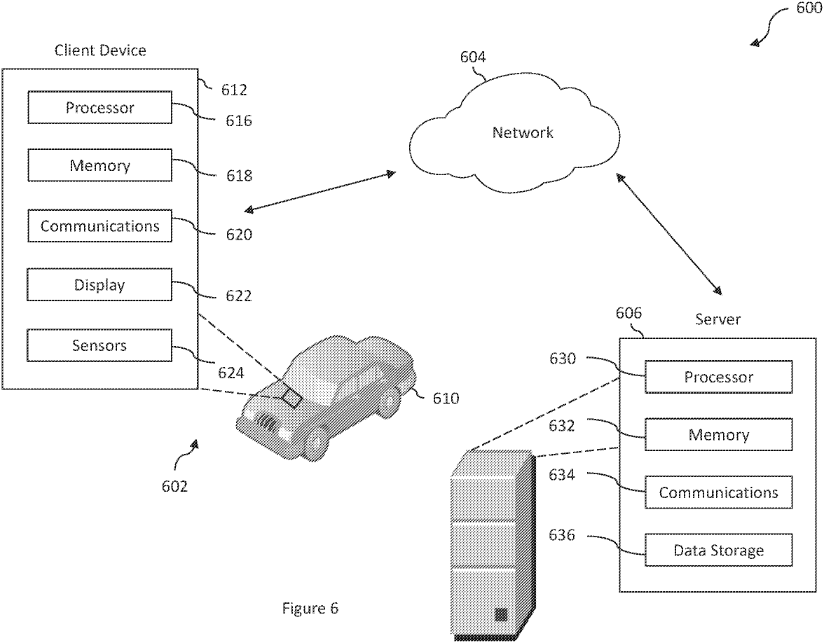

FIG. 6 is a simplified system for managing vehicle insurance according to certain embodiments of the present disclosure. The diagram is merely an example, which should not unduly limit the scope of the claims. One of ordinary skill in the art would recognize many variations, alternatives, and modifications. The system 600 includes a vehicle system 602, a network 604, and a server 606. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the system 600 is used to implement the method 100, the method 200, the method 300, and/or the method 400. According to certain embodiments, the vehicle system 602 includes a vehicle 610 and a client device 612 associated with the vehicle 610. For example, the client device 612 is an on-board computer embedded or located in the vehicle 610. As an example, the client device 612 is a mobile device (e.g., a smartphone) that is connected (e.g., via wired or wireless links) to the vehicle 610. As an example, the client device 612 includes a processor 616 (e.g., a central processing unit (CPU), a graphics processing unit (GPU)), a memory 618 (e.g., RAM, ROM, flash memory), a communications unit 620 (e.g., a network transceiver), a display unit 622 (e.g., a touchscreen), and one or more sensors 624 (e.g., an accelerometer, a gyroscope, a magnetometer, a barometer, a GPS sensor).

In some embodiments, the vehicle 610 is operated by the user. In certain embodiments, multiple vehicles 610 exist in the system 600 which are operated by respective users. As an example, during vehicle trips, the one or more sensors 624 monitor the vehicle 610 by collecting data associated with various operating parameters of the vehicle, such as speed, acceleration, braking, location, engine status, fuel level, as well as other suitable parameters. In certain embodiments, the collected data include vehicle telematics data. According to some embodiments, the data are collected continuously, at predetermined time intervals, and/or based on a triggering event (e.g., when each sensor has acquired a threshold amount of sensor measurements).

According to certain embodiments, the collected data are stored in the memory 618 before being transmitted to the server 606 using the communications unit 620 via the network 604 (e.g., via a local area network (LAN), a wide area network (WAN), the Internet). In some embodiments, the collected data are transmitted directly to the server 606 via the network 604. In certain embodiments, the collected data are transmitted to the server 606 via a third party. For example, a data monitoring system stores any and all data collected by the one or more sensors 1024 and transmits those data to the server 606 via the network 604 or a different network.

According to certain embodiments, the server 606 includes a processor 630 (e.g., a microprocessor, a microcontroller), a memory 632, a communications unit 634 (e.g., a network transceiver), and a data storage 636 (e.g., one or more databases). In some embodiments, the server 606 is a single server, while in certain embodiments, the server 606 includes a plurality of servers with distributed processing. In FIG. 6, the data storage 636 is shown to be part of the server 606. In some embodiments, the data storage 636 is a separate entity coupled to the server 606 via a network such as the network 604. In certain embodiments, the server 606 includes various software applications stored in the memory 632 and executable by the processor 630. For example, these software applications include specific programs, routines, or scripts for performing functions associated with the method 100, the method 200, the method 300, and/or the method 400. As an example, the software applications include general-purpose software applications for data processing, network communication, database management, web server operation, and/or other functions typically performed by a server.

According to various embodiments, the server 606 receives, via the network 604, the data collected by the one or more sensors 624 using the communications unit 634 and stores the data in the data storage 636. For example, the server 606 then processes the data to perform one or more processes of the method 100, one or more processes of the method 200, one or more processes of the method 300, and/or one or more processes of the method 400.

According to certain embodiments, any related information determined or generated by the method 100, the method 200, the method 300, and/or the method 400 are transmitted back to the client device 612, via the network 604, to be provided (e.g., displayed) to the user via the display unit 622.

In some embodiments, one or more processes of the method 100, one or more, or all, processes of the method 200, one or more, or all, processes of the method 300, and/or one or more, or all, processes of the method 400 are performed by the client device 612. For example, the processor 616 of the client device 612 processes the data collected by the one or more sensors 624 to perform one or more processes of the method 100, one or more processes of the method 200, one or more processes of the method 300, and/or one or more processes of the method 400.

### VII. Examples of Certain Embodiments of the Present Disclosure

According to certain embodiments, a method for providing vehicle insurance discounts includes presenting, by a computing device, one or more questions to a user, and receiving, from the user by the computing device, one or more responses to the one or more questions. Also, the method includes determining, by the computing device, a first discount value for an insurance policy of a vehicle based at least in part upon the one or more responses. Additionally, the method includes applying, by the computing device, the first discount value to the insurance policy of the vehicle for a predetermined period of time. Further, the method includes collecting, by the computing device, driving data associated with one or more trips made by the vehicle during the predetermined period of time. Moreover, the method includes analyzing, by the computing device, the driving data and the one or more responses. The method may also include determining, by the computing device, a first weight and a second weight based at least in part upon the driving data. For example, the method is implemented according to at least FIG. 1.

According to some embodiments, a computing device for providing vehicle insurance discounts includes one or more processors and a memory storing instructions for execution by the one or more processors. The instructions, when executed, cause the one or more processors to present one or more questions to a user and receive, from the user, one or more responses to the one or more questions. Also, the instructions, when executed, cause the one or more processors to determine a first discount value for an insurance policy of a vehicle based at least in part upon the one or more responses. Additionally, the instructions, when executed, cause the one or more processors to apply the first discount value to the insurance policy of the vehicle for a predetermined period of time. Further, the instructions, when executed, cause the one or more processors to collect driving data associated with one or more trips made by the vehicle during the predetermined period of time. Further, the instructions, when executed, cause the one or more processors to analyze the driving data and the one or more responses. Moreover, the instructions, when executed, cause the one or more processors to determine a first weight and a second weight based at least in part upon the driving data. For example, the computing device is implemented according to at least FIG. 1, FIG. 5 and/or FIG. 6.

According to some embodiments, a non-transitory computer-readable medium stores instructions for providing vehicle insurance discounts. The instructions are executed by one or more processors of a computing device. The non-transitory computer-readable medium includes instructions to present one or more questions to a user, and to receive, from the user, one or more responses to the one or more questions. Also, the non-transitory computer-readable medium includes instructions to determine a first discount value for an insurance policy of a vehicle based at least in part upon the one or more responses. Additionally, the non-transitory computer-readable medium includes instructions to apply the first discount value to the insurance policy of the vehicle for a predetermined period of time. Further, the non-transitory computer-readable medium includes instructions to collect driving data associated with one or more trips made by the vehicle during the predetermined period of time. Further, the non-transitory computer-readable medium includes instructions to analyze the driving data and the one or more responses. Moreover, the non-transitory computer-readable medium includes instructions to determine a first weight and a second weight based at least in part upon the driving data. For example, the non-transitory computer-readable medium is implemented in accordance with at least FIG. 1, FIG. 5 and/or FIG. 6.

According to some embodiments, a method for evaluating driving behaviors includes presenting, by a computing device, one or more questions to a user, and receiving, from the user by the computing device, one or more responses to the one or more questions. Also, the method includes analyzing, by the computing device, the one or more responses to determine a set of expected driving behaviors of the user for a predetermined period of time. Additionally, the method includes collecting, by the computing device, driving data associated with one or more trips made by a vehicle during the predetermined period of time. Further, the method includes analyzing, by the computing device, the driving data to determine a set of actual driving behaviors of the user. Moreover, the method includes determining, by the computing device, one or more relationships between the set of expected driving behaviors and the set of actual driving behaviors. For example, the method is implemented according to at least FIG. 2.

Certain embodiments of the method for evaluating driving behaviors further comprise analyzing, by the computing device, the one or more relationships between the set of expected driving behaviors and the set of actual driving behaviors to determine a discount value to an insurance policy for the vehicle of the user.

Certain embodiments of the method for evaluating driving behaviors further comprise if the one or more relationships between the set of expected driving behaviors and the set of actual driving behaviors satisfy one or more predetermined conditions, determining, by the computing device, that the set of expected driving behaviors is validated.

Certain embodiments of the method for evaluating driving behaviors further comprise if the one or more relationships between the set of expected driving behaviors and the set of actual driving behaviors do not satisfy the one or more predetermined conditions, determining, by the computing device, that the set of expected driving behaviors is not validated.

According to some embodiments, a computing device for evaluating driving behaviors includes one or more processors and a memory storing instructions for execution by the one or more processors. The instructions, when executed, cause the one or more processors to present one or more questions to a user, and receive, from the user, one or more responses to the one or more questions. Also, the instructions, when executed, cause the one or more processors to analyze the one or more responses to determine a set of expected driving behaviors of the user for a predetermined period of time. Additionally, the instructions, when executed, cause the one or more processors to collect driving data associated with one or more trips made by a vehicle during the predetermined period of time. Further, the instructions, when executed, cause the one or more processors to analyze the driving data to determine a set of actual driving behaviors of the user. Moreover, the instructions, when executed, cause the one or more processors to determine one or more relationships between the set of expected driving behaviors and the set of actual driving behaviors. For example, the computing device is implemented according to at least FIG. 2, FIG. 5 and/or FIG. 6.

According to some embodiments, a non-transitory computer-readable medium stores instructions for evaluating driving behaviors. The instructions are executed by one or more processors of a computing device. The non-transitory computer-readable medium includes instructions to present one or more questions to a user, and to receive, from the user, one or more responses to the one or more questions. Also, the non-transitory computer-readable medium includes instructions to analyze the one or more responses to determine a set of expected driving behaviors of the user for a predetermined period of time. Additionally, the non-transitory computer-readable medium includes instructions to collect driving data associated with one or more trips made by a vehicle during the predetermined period of time. Further, the non-transitory computer-readable medium includes instructions to analyze the driving data to determine a set of actual driving behaviors of the user. Moreover, the non-transitory computer-readable medium includes instructions to determine one or more relationships between the set of expected driving behaviors and the set of actual driving behaviors. For example, the non-transitory computer-readable medium is implemented according to at least FIG. 2, FIG. 5 and/or FIG. 6.

According to some embodiments, a method for evaluating telematics-based insurance ratings includes receiving, by a computing device, a telematics-based insurance rating of a user, the telematics-based insurance rating being associated with a previous insurance provider for the user. Also, the method includes generating, by the computing device, an initial insurance discount for a vehicle of the user based at least in part upon the telematics-based insurance rating of the user, the initial insurance discount being associated with a current insurance provider for the user. Additionally, the method includes receiving, by the computing device, previous user data generated by the previous insurance provider, the previous user data representing one or more driving characteristics of the user. Further, the method includes analyzing, by the computing device, the previous user data to determine an updated insurance discount for the vehicle of the user. For example, the method is implemented according to at least FIG. 3.

In certain embodiments of the method for evaluating telematics-based insurance ratings, the receiving, by the computing device, the previous user data generated by the previous insurance provider includes receiving the previous user data from the user.

In certain embodiments of the method for evaluating telematics-based insurance ratings the receiving, by the computing device, the previous user data generated by the previous insurance provider includes receiving the previous user data from the previous insurance provider.

In certain embodiments of the method for evaluating telematics-based insurance ratings further comprises determining, by the computing device, whether one or more relationships between the initial insurance discount and the updated insurance discount satisfy one or more predetermined conditions.

In certain embodiments of the method for evaluating telematics-based insurance ratings further comprises if the one or more relationships between the initial insurance discount and the updated insurance discount satisfy the one or more predetermined conditions, determining, by the computing device, that the initial insurance discount is verified.

In certain embodiments of the method for evaluating telematics-based insurance ratings further comprises if the one or more relationships between the initial insurance discount and the updated insurance discount do not satisfy the one or more predetermined conditions, determining, by the computing device, that the initial insurance discount is not verified.

According to some embodiments, a computing device for evaluating telematics-based insurance ratings includes one or more processors and a memory storing instructions for execution by the one or more processors. The instructions, when executed, cause the one or more processors to receive a telematics-based insurance rating of a user, the telematics-based insurance rating being associated with a previous insurance provider for the user. Also, the instructions, when executed, cause the one or more processors to generate an initial insurance discount for a vehicle of the user based at least in part upon the telematics-based insurance rating of the user, the initial insurance discount being associated with a current insurance provider for the user. Additionally, the instructions, when executed, cause the one or more processors to receive previous user data generated by the previous insurance provider, the previous user data representing one or more driving characteristics of the user. Moreover, the instructions, when executed, cause the one or more processors to analyze the previous user data to determine an updated insurance discount for the vehicle of the user. For example, the method is implemented according to at least FIG. 3, FIG. 5 and/or FIG. 6.

According to some embodiments, a non-transitory computer-readable medium stores instructions for evaluating telematics-based insurance ratings. The instructions are executed by one or more processors of a computing device The non-transitory computer-readable medium includes instructions to receive a telematics-based insurance rating of a user, the telematics-based insurance rating being associated with a previous insurance provider for the user. Also, the non-transitory computer-readable medium includes instructions to generate an initial insurance discount for a vehicle of the user based at least in part upon the telematics-based insurance rating of the user, the initial insurance discount being associated with a current insurance provider for the user. Additionally, the non-transitory computer-readable medium includes instructions to receive previous user data generated by the previous insurance provider, the previous user data representing one or more driving characteristics of the user. Further, the non-transitory computer-readable medium includes instructions to analyze the previous user data to determine an updated insurance discount for the vehicle of the user. For example, the non-transitory computer-readable medium is implemented according to at least FIG. 3, FIG. 5 and/or FIG. 6.

According to some embodiments, a method for sharing one or more vehicle insurance discounts includes analyzing, by a computing device, first driving data of a first user to determine one or more first driving behaviors of the first user. Additionally, the method includes determining, by the computing device, a discount value for an insurance policy of a vehicle based at least in part upon the one or more first driving behaviors of the first user. Further, the method includes receiving, by the computing device, information about a second user from the first user. Moreover, the method includes providing, to the second user by the computing device, the discount value of the first user to the second user. Also, the method includes receiving, from the second user by the computing device, an acceptance of the discount value. Furthermore, the method includes analyzing, by the computing device, second driving data of the second user to determine one or more second driving behaviors of the second user. For example, the method is implemented according to at least FIG. 4.

In certain embodiments, the method for sharing one or more vehicle insurance discounts further comprises comparing, by the computing device, the one or more second driving behaviors with the one or more first driving behaviors to determine one or more differences; and determining, by the computing device, a reward for the first user based at least in part upon the one or more differences.

In certain embodiments, the method for sharing one or more vehicle insurance discounts further comprises determining, by the computing device, a reward for the first user based at least in part upon the one or more second driving behaviors.

According to some embodiments, a computing device for sharing one or more vehicle insurance discounts includes one or more processors and a memory storing instructions for execution by the one or more processors. The instructions, when executed, cause the one or more processors to analyze first driving data of a first user to determine one or more first driving behaviors of the first user. Additionally, the instructions, when executed, cause the one or more processors to determine a discount value for an insurance policy of a vehicle based at least in part upon the one or more first driving behaviors of the first user. Further, the instructions, when executed, cause the one or more processors to receive information about a second user from the first user. Moreover, the instructions, when executed, cause the one or more processors to provide, to the second user, the discount value of the first user to the second user. Also, the instructions, when executed, cause the one or more processors to receive, from the second user, an acceptance of the discount value. Furthermore, the instructions, when executed, cause the one or more processors to analyze second driving data of the second user to determine one or more second driving behaviors of the second user. For example, the computing device is implemented according to at least FIG. 4, FIG. 5 and/or FIG. 6.

According to some embodiments, a non-transitory computer-readable medium stores instructions for sharing one or more vehicle insurance discounts. The instructions are executed by one or more processors of a computing device. The non-transitory computer-readable medium includes instructions to analyze first driving data of a first user to determine one or more first driving behaviors of the first user. Also, the non-transitory computer-readable medium includes instructions to determine a discount value for an insurance policy of a vehicle based at least in part upon the one or more first driving behaviors of the first user. Additionally, the non-transitory computer-readable medium includes instructions to receive information about a second user from the first user. Further, the non-transitory computer-readable medium includes instructions to provide, to the second user, the discount value of the first user to the second user. Moreover, the non-transitory computer-readable medium includes instructions to receive, from the second user, an acceptance of the discount value. Furthermore, the non-transitory computer-readable medium includes instructions to analyze second driving data of the second user to determine one or more second driving behaviors of the second user. For example, the non-transitory computer-readable medium is implemented according to at least FIG. 4, FIG. 5 and/or FIG. 6.

According to some embodiments, a method for providing vehicle insurance discounts comprises presenting, by a computing device, one or more questions to a user, and receiving, from the user by the computing device, one or more initial responses to the one or more questions. Additionally, the method comprises determining, by the computing device, a first discount value for an insurance policy of a vehicle based at least in part upon the one or more initial responses. Further, the method comprises applying, by the computing device, the first discount value to the insurance policy of the vehicle for a predetermined period of time. Moreover, the method comprises collecting, by the computing device, driving data associated with one or more trips made by the vehicle during the predetermined period of time. Also, the method comprises analyzing, by the computing device, the driving data and the one or more initial responses. Furthermore, the method comprises determining, by the computing device, a first weight and a second weight based at least in part upon the driving data. Additionally, the method comprises collecting, by the computing device, one or more updated responses to the one or more questions. Moreover, the method comprises changing, by the computing device, the first weight and the second weight based at least in part upon the one or more updated responses. For example, the method is implemented according to at least FIG. 1.

According to some embodiments, a system for providing vehicle insurance discounts comprises means for presenting one or more questions to a user, and means for receiving one or more responses to the one or more questions. Additionally, the system comprises means for determining a first discount value for an insurance policy of a vehicle based at least in part upon the one or more responses. Further, the system comprises means for applying the first discount value to the insurance policy of the vehicle for a predetermined period of time. Moreover, the system comprises means for collecting driving data associated with one or more trips made by the vehicle during the predetermined period of time. Furthermore, the system comprises means for analyzing the driving data and the one or more responses. Also, the system comprises means for determining a first weight and a second weight based at least in part upon the driving data. For example, the computing device is implemented according to at least FIG. 1, FIG. 5 and/or FIG. 6.

### VIII. Examples of Machine Learning According to Certain Embodiments

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or actual repair costs. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

### IX. Additional Considerations According to Certain Embodiments

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems’ and methods’ data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer’s hard drive, DVD) that contain instructions (e.g., software) for use in execution by a processor to perform the methods’ operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for providing vehicle insurance discounts, the method comprising:
presenting, by a computing device, one or more questions to a user;
receiving, from the user by the computing device, one or more responses to the one or more questions;
determining, by the computing device, a first discount value for an insurance policy of a vehicle based at least in part upon the one or more responses;
applying, by the computing device, the first discount value to the insurance policy of the vehicle for a predetermined period of time;
collecting, by the computing device, driving data associated with one or more trips made by the vehicle during the predetermined period of time;
analyzing, by the computing device, the driving data and the one or more responses; and
determining, by the computing device, a first weight and a second weight based at least in part upon the driving data.

2. The method of claim 1, wherein the driving data corresponds to a driving mileage.

3. The method of claim 2, wherein the determining, by the computing device, the first weight and the second weight based at least in part upon the driving data includes:
increasing the first weight and decreasing the second weight if the driving mileage increases but remains smaller than a predetermined mileage threshold; and
setting the first weight equal to one and the second weight equal to zero if the driving mileage reaches or becomes larger than the predetermined mileage threshold.

4. The method of claim 1, further comprising:
determining, by the computing device, one or more first weighted factors based at least in part upon the first weight and the driving data;
determining, by the computing device, one or more second weighted factors based at least in part upon the second weight and the one or more responses;
determining, by the computing device, a second discount value for the insurance policy of the vehicle based at least in part upon the one or more first weighted factors and the one or more second weighted factors; and
after the predetermined period of time,
replacing, by the computing device, the first discount value with the second discount value; and
applying, by the computing device, the second discount value to the insurance policy of the vehicle.

5. The method of claim 4, wherein the determining, by the computing device, the one or more first weighted factors includes:
determining one or more weighted driving data by applying the first weight to the driving data, the one or more first weighted factors including the one or more weighted driving data.

6. The method of claim 5, wherein the determining, by the computing device, the one or more second weighted factors includes:
determining one or more weighted responses by applying the second weight to the one or more responses, the one or more second weighted factors including the one or more weighted responses.

7. The method of claim 6, wherein the determining, by the computing device, the second discount value for the insurance policy of the vehicle includes:
determining the second discount value based at least in part upon the one or more weighted responses and the one or more weighted driving data.

8. A computing device for providing vehicle insurance discounts, the computing device comprising:
one or more processors; and
a memory storing instructions that, when executed by the one or more processors, cause the one or more processors to:
present one or more questions to a user;
receive, from the user, one or more responses to the one or more questions;
determine a first discount value for an insurance policy of a vehicle based at least in part upon the one or more responses;
apply the first discount value to the insurance policy of the vehicle for a predetermined period of time;
collect driving data associated with one or more trips made by the vehicle during the predetermined period of time;
analyze the driving data and the one or more responses; and
determine a first weight and a second weight based at least in part upon the driving data.

9. The computing device of claim 8, wherein the driving data corresponds to a driving mileage.

10. The computing device of claim 9, wherein the determining the first weight and the second weight based at least in part upon the driving data includes:
increasing the first weight and decreasing the second weight if the driving mileage increases but remains smaller than a predetermined mileage threshold; and
setting the first weight equal to one and the second weight equal to zero if the driving mileage reaches or becomes larger than the predetermined mileage threshold.

11. The computing device of claim 8, wherein the instructions further cause the one or more processors to:
determine one or more first weighted factors based at least in part upon the first weight and the driving data;
determine one or more second weighted factors based at least in part upon the second weight and the one or more responses;
determine a second discount value for the insurance policy of the vehicle based at least in part upon the one or more first weighted factors and the one or more second weighted factors; and
after the predetermined period of time,
replace the first discount value with the second discount value; and
apply the second discount value to the insurance policy of the vehicle.

12. The computing device of claim 11, wherein the determining the one or more first weighted factors includes:
determining one or more weighted driving data by applying the first weight to the driving data, the one or more first weighted factors including the one or more weighted driving data.

13. The computing device of claim 12, wherein the determining the one or more second weighted factors includes:
determining one or more weighted responses by applying the second weight to the one or more responses, the one or more second weighted factors including the one or more weighted responses.

14. The computing of claim 13, wherein the determining the second discount value for the insurance policy of the vehicle includes:
determining the second discount value based at least in part upon the one or more weighted responses and the one or more weighted driving data.

15. A non-transitory computer-readable medium storing instructions for providing vehicle insurance discounts, the instructions when executed by one or more processors of a computing device, cause the computing device to:
present one or more questions to a user;
receive, from the user, one or more responses to the one or more questions;
determine a first discount value for an insurance policy of a vehicle based at least in part upon the one or more responses;
apply the first discount value to the insurance policy of the vehicle for a predetermined period of time;
collect driving data associated with one or more trips made by the vehicle during the predetermined period of time;
analyze the driving data and the one or more responses; and
determine a first weight and a second weight based at least in part upon the driving data.

16. The non-transitory computer-readable medium of claim 15, wherein the driving data corresponds to a driving mileage.

17. The non-transitory computer-readable medium of claim 16, wherein the determining the first weight and the second weight based at least in part upon the driving data includes:
increasing the first weight and decreasing the second weight if the driving mileage increases but remains smaller than a predetermined mileage threshold; and
setting the first weight equal to one and the second weight equal to zero if the driving mileage reaches or becomes larger than the predetermined mileage threshold.

18. The non-transitory computer-readable medium of claim 15, wherein the instructions further cause the computing device to:
determine one or more first weighted factors based at least in part upon the first weight and the driving data;
determine one or more second weighted factors based at least in part upon the second weight and the one or more responses;
determine a second discount value for the insurance policy of the vehicle based at least in part upon the one or more first weighted factors and the one or more second weighted factors; and
after the predetermined period of time,
replace the first discount value with the second discount value; and
apply the second discount value to the insurance policy of the vehicle.

19. The non-transitory computer-readable medium of claim 18, wherein the determining the one or more first weighted factors includes:
determining one or more weighted driving data by applying the first weight to the driving data, the one or more first weighted factors including the one or more weighted driving data.

20. The non-transitory computer-readable medium of claim 19, wherein the determining the one or more second weighted factors includes:
determining one or more weighted responses by applying the second weight to the one or more responses, the one or more second weighted factors including the one or more weighted responses.

21. A system for providing vehicle insurance discounts, the system comprising:
means for presenting one or more questions to a user;
means for receiving one or more responses to the one or more questions;
means for determining a first discount value for an insurance policy of a vehicle based at least in part upon the one or more responses;
means for applying the first discount value to the insurance policy of the vehicle for a predetermined period of time;
means for collecting driving data associated with one or more trips made by the vehicle during the predetermined period of time;
means for analyzing the driving data and the one or more responses; and
means for determining a first weight and a second weight based at least in part upon the driving data.
